(19) United States
(12) Patent Application Publication
(10) Pub. No.: US 2025/0013334 A1
(43) Pub. Date: Jan. 9, 2025

(54) Force Sensing Device

(71) Applicant: Peratech IP Ltd., Catterick Garrison (GB)

(72) Inventor: Sarah Jessica Dempsey, Durham (GB)

(21) Appl. No.: 18/888,389

(22) Filed: Sep. 18, 2024

Related U.S. Application Data
(63) Continuation of application No. PCT/GB2023/000016, filed on Mar. 17, 2023.

(30) Foreign Application Priority Data
Mar. 18, 2022 (GB) 2203792.3

(51) Int. Cl. G06F 3/044; G06F 3/02; G06F 3/041

(52) U.S. Cl. CPC G06F 3/0445; G06F 3/02; G06F 3/0414

(57) ABSTRACT

A force sensing device, comprises a first electrode layer comprising a material having a first resistivity and a second electrode layer comprising a pressure sensitive material having a second resistivity. The second resistivity is relatively high compared to the first resistivity. The first and second electrode layers are configured to be brought together under an applied force. A first conductive material is applied to the first electrode layer and a second conductive material is applied to the second electrode layer to produce first and second moderator layers, respectively. The first and second conductive materials each comprise a material having a resistivity lower than the first and second resistivities, such that, when the first and second conductive materials are brought into contact under the applied force, the current flow between the first and second conductive materials is dependent on the contact area between the first and second moderator layers.

### CROSS REFERENCE TO RELATED APPLICATIONS

This application is a continuation of and claims priority to International Patent Application number PCT/GB2023/000016, filed on 17 Mar. 2023, which claims priority from United Kingdom Patent Application number 22 03 792.3, filed on 18 Mar. 2022. The whole contents of International Patent Application number PCT/GB2023/000016 and United Kingdom Patent Application number 22 03 792.3 are incorporated herein by reference.

### BACKGROUND OF THE INVENTION

The present invention relates to a force sensing device, and an electronic device comprising a force sensing device.

Force sensing devices are used in many applications and may be provided in many different shapes, sizes and of different technologies, each having their own limitations.

A limitation of existing force sensing devices is that conventional force sensors often employ contact resistance (the electrical resistance that arises at a contact point when components are connected) as a key mechanism by which a changing resistance can be generated. In such cases, these types of force sensors are sensitive to mechanical interface material changes, such as, but not limited to, hardness and roughness.

This can lead to problems with stability of the force sensor, as the outputs from the sensor are dependent on how these mechanical properties change as a function of the surrounding environment. An example of such an environment could be the application of a constant force, while raising the ambient temperature. This would result in a change in the measured sensor resistance, due to the change in mechanical material properties consequently changing the contact resistance. Other environments or scenarios could produce similar results.

There remains a need for alternative force sensing devices which are able to avoid these issues and are not dependent on the contact resistance between components.

### BRIEF SUMMARY OF THE INVENTION

According to an aspect of the present invention, there is provided a force sensing device, a first electrode layer comprising a material having a first resistivity; a second electrode layer comprising a pressure sensitive material having a second resistivity, said second resistivity being relatively high compared to said first resistivity, and, said first electrode layer and said second electrode layer arranged apart and configured to be brought together under an applied force; and a first conductive material applied to said first electrode layer to produce a first moderator layer and a second conductive material applied to said second electrode layer to produce a second moderator layer; wherein said first conductive material and said second conductive material each comprise a material having a substantially low resistivity, said low resistivity being lower than said first resistivity and said second resistivity, such that, when said first and second conductive materials are brought into contact under an applied force, the current flow between said first and second conductive materials is dependent on contact area between said first and second moderator layers.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art.

### BRIEF DESCRIPTION OF THE SEVERAL VIEWS OF THE DRAWINGS

FIG. 1 shows a contact resistance dependent construction of an existing force sensing device;

FIG. 2 shows a contact resistance free force sensing device construction;

FIG. 3 shows a top-down view of one implementation of a contact resistance free force sensing device arrangement;

FIG. 4 shows a further plan view of the contact resistance free force sensing device arrangement of FIG. 3; and

FIG. 5 shows an example electronic device utilizing the force sensing device of the present invention.

### DETAILED DESCRIPTION OF EMBODIMENTS OF THE INVENTION

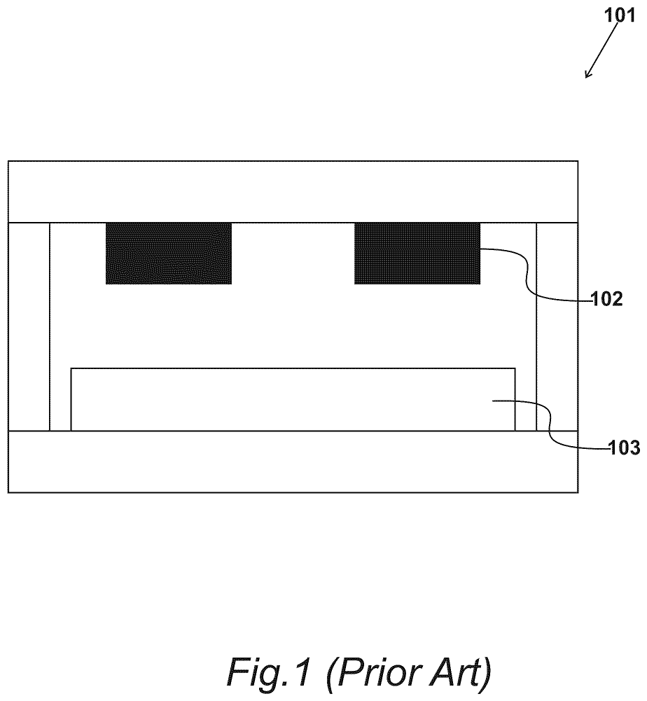

### FIG. 1

The application proposes a force sensing device which eliminates, or minimizes, the contact resistance component of such a force sensing device, thereby improving sensor stability independently from the fluctuating and changing environmental conditions around it.

A contact resistance dependent force sensing device 101 in line with conventional devices is shown in FIG. 1. In conventional force sensors, a low or moderate resistivity electrode 102 is combined with a high resistance base layer 103.

The example in FIG. 1 shows a simplified side-view construction of a typical contact resistance dependent force sensing device 101. The contact resistance dependent sensor construction of FIG. 1 comprises two sides of an interface, with a first side comprising a low or moderate resistivity electrode 102, which further includes a positive voltage electrode and ground electrode.

A second side of force sensing device 101 comprises a high resistivity material, which has the required resistivity to make contact resistance a key mechanism in this sensor design.

In use, a force is applied to force sensing device 101 and current flows when electrode 102 comes into contact with base layer 103. The extent of the current flow is governed by the pressure at the interface between electrode 102 and base layer 103, which results from the applied force. This conventional construction is very sensitive to changes in the mechanical properties of the interfacing materials used.

This is due to the fact that force sensing device relies on the contact resistance, which arises at the contact point at the interfaces between the electrode 102 and the base layer 103 when the materials are pressed together. The force applied affects the number of micro contacts between the two surfaces of the electrode and base layer.

The main problem with prior art arrangements of this type is that while the material changes its resistivity on applied force, the contact resistance changes as the force sensing device experiences environmental changes or difference scenarios. For example, at higher temperatures, the component materials may be softer which impacts on the contact resistance which is dependent on material hardness. In an example, if material hardness reduces by thirty percent (30%), the contact resistance decreases by around thirty percent (30%). This is a significant and undesirable performance change which is difficult to overcome with firmware or software solutions.

FIG. 1 therefore shows a contact resistance dependent force sensing device having a low to moderate resistivity layer comprising interdigitated fingers and a high resistivity layer, such as one comprising a quantum tunnelling composite material.

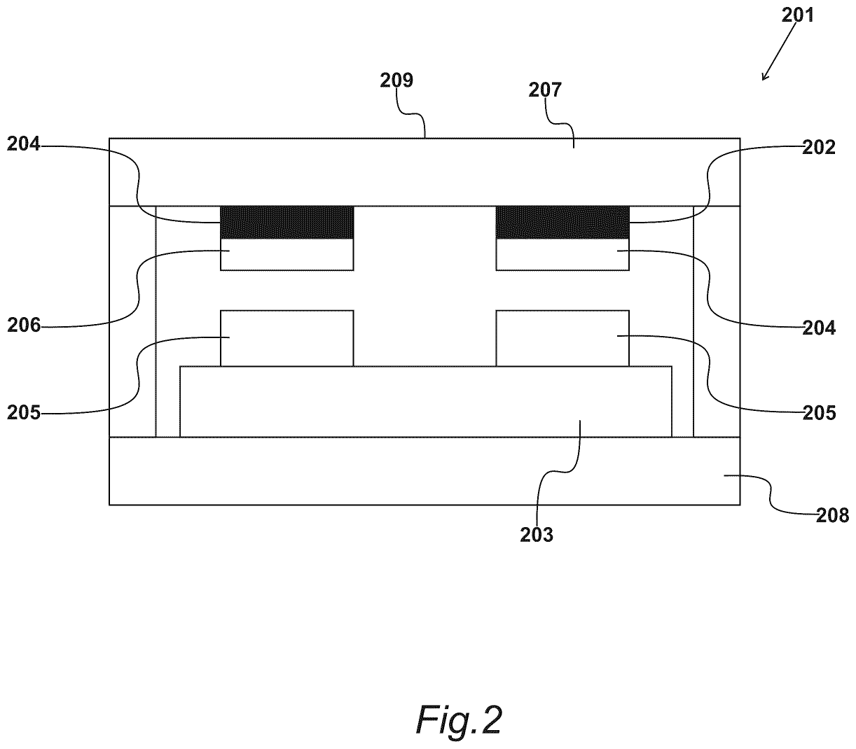

### FIG. 2

In order to provide a force sensing device which is less responsive to temperature the invention described herein removes the resistance at the interface between the materials that touch across the air gap present in the force sensing device.

FIG. 2 shows a simplified side-view construction of a contact resistance free force sensing device.

Force sensing device 201 comprises a first electrode layer 202 and a second electrode layer 203. Each electrode layer provides an alternate side of an interface which is configured to be brought together and into contact to provide an electrical output in response to an applied force.

Force sensing device 201 further comprises a first moderator layer 204 and a second moderator layer 205. In the embodiment, electrode layer 202 comprises a material having a first resistivity and electrode layer 203 comprises a pressure sensitive material having a second resistivity. The first resistivity is moderate or low while the second resistivity is relatively high compared to the first resistivity. In the embodiment, electrode layer 202 and electrode layer 203 are arranged apart from each other and separated by means of an air gap 206 and are configured to be brought together on application of a force applied to force sensing device 201. Air gap 206 is positioned between first moderator layer 204 and second moderator layer 205.

Moderator layer 204 comprises a first conductive material which is applied to electrode layer 202 while moderator layer 205 comprises a second conductive material which is applied to electrode layer 203.

In the embodiment, moderator layer 204 is in intimate contact with electrode layer 202, which, in this context, is considered to indicate a lack of contact resistance between the interface of the electrode layer and the moderator layer. Similarly, moderator layer 205 is in intimate contact with electrode layer 203.

In the embodiment, air gap 206 separates the two sides of the interface and electrode layer 202 and electrode layer 203 are arranged a distance apart. Consequently, moderator layer 204 and moderator layer 205 are also arranged a distance apart from each other. In addition, electrode layer 202 and electrode layer 203 are provided on a first substrate 207 and a second substrate 208 respectively. The substrates are spaced apart by means of a conventional 20 spacer element or similar which ensures air gap 206 is retained in the absence of an applied force.

In the embodiment, moderator layer 204 and moderator layer 205 are suitably aligned to ensure contact between moderator layer 204 and moderator layer 205 only happens in response to an applied force to the force sensing device in which the air gap 206 reduces and is minimized.

In the embodiment, moderator layers 204 and 205 have a very low resistivity. In an embodiment, this is a resistivity value which is typically less than 10⁻⁷ ohm-meter (Ωm), meaning that when moderator layer 204 and moderator layer 205 are brought into contact with each other in a non-intimate way, the contact resistance is extremely small, as its absolute value is dependent on an aggregate of the resistivities of the contacting sides of the interface. If one side of the force sensing device has a high resistance, as in some conventional systems, this dominates the aggregate, resulting in a contact resistance that is large. Thus, in the embodiment, as both sides of the interface have a low resistance, the aggregate of the resistivities is also low. Thus, by introducing low resistivity moderator layers 204 and 205 to provide the contact interface between the two electrodes, the force sensing device described herein is substantially contact resistance free.

By introducing moderator layer 204 and moderator layer 205, the resulting force sensing device cannot be dependent solely on contact resistance, otherwise an electrical short will occur when the two opposing sides of the interface touch. Thus, electrode layer 203 needs to be high in resistivity on the opposing side of moderator layer 203 to the interface. Typically, moderator layer 203 further comprises relatively small features which are not limited by shape or distribution. In contrast, moderator layer 204 may comprise a range of patterns. In an embodiment, such a pattern may be substantially similar to moderator layer 203. Alternative arrangements may be utilized, however, in each case moderator layer 203 and moderator layer 204 are configured to provide the only contact at the interface between the two halves of the force sensing device.

In use, when a force is applied to the upper surface 209 of force sensing device 201, electrode layer 202 and moderator layer 204 are brought towards moderator layer 205 and electrode layer 203. Force sensing device 201 is connected to an electrical circuit such that current is able to flow when moderator layer 204 and moderator layer 205 come into contact. The extent of the current flow is not governed by the pressure at the contact interface, but instead by the macroscopic contact area. This ensures that the construction of force sensing device 201 is not sensitive to changes in the mechanical properties of the materials used at the contact interface (the point at which contact is made).

To ensure that the force sensing device exhibits a change in resistance with respect to force, it is necessary to have a changing macroscopic contact area as a function of force at the contact interface. This is different from the microscopic “true” contact area change observed in conventional force sensing devices which are dependent on contact resistance. The macroscopic contact area is defined as the area over which the air gap is sufficiently small such that moderator layer 204 and moderator layer 205 are deemed to be touching.

The increased macroscopic contact area, as a function of applied force, results in an increasing number of parallel current paths through the high resistivity material of electrode layer 203. This increasing number of parallel current paths therefore produce a subsequent decreasing overall resistance between the first and second electrode layers 203, 204.

Thus, force sensing device 201 provides a solution by removing the high resistivity material of electrode layer 203 from being the direct contact at the contact interface, and replaces this with a corresponding moderator layer 205 which provides a lower resistivity to achieve these effects.

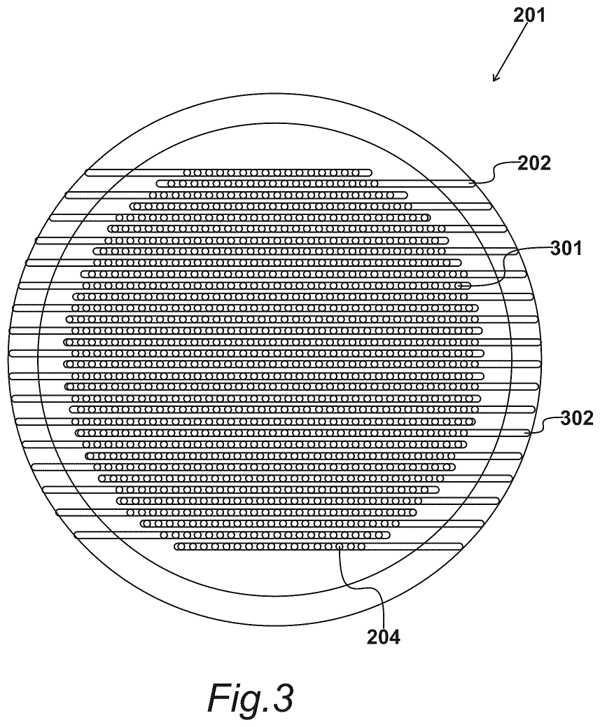

### FIG. 3

A top-down view of force sensing device 201 is shown in FIG. 3, illustrating an example embodiment and arrangement of electrode layer 202 and moderator layer 204.

In the embodiment, the first conductive material of moderator layer 204 comprises a silver-based material, such as a silver-based ink. The material having a first resistivity of the electrode layer 202 comprises a carbon-based material.

In the embodiment, the first conductive material comprising the moderator layer 204 is provided in the form of a printed pattern as shown in FIG. 3. In this particular embodiment, the printed pattern comprises a plurality of dots 301, although it is appreciated that alternative patterns may be utilized. In an alternative embodiment, for example, the printed pattern comprises a plurality of interdigitated fingers.

In the embodiment, electrode layer 202 comprises a plurality of interdigitated fingers 302. In the embodiment where the printed pattern also comprises a plurality of interdigitated fingers, it is appreciated that each plurality of interdigitated fingers may be substantially similar and aligned with each other.

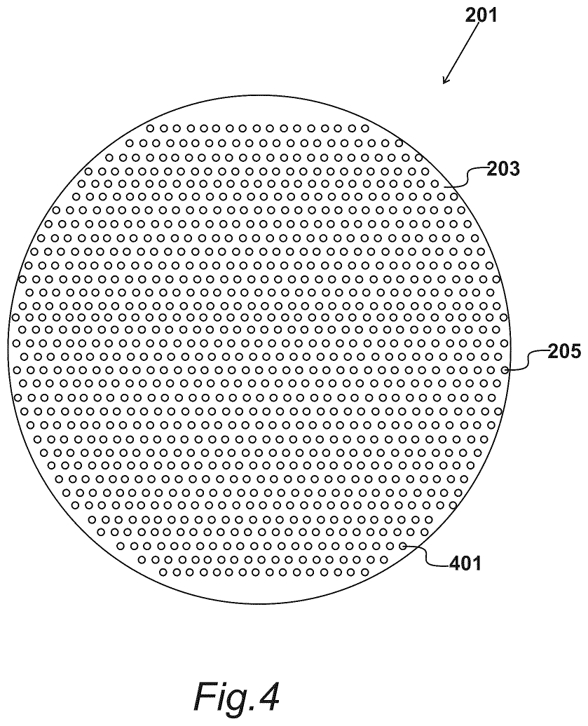

### FIG. 4

A further plan view from the underside of the force sensing device 201 is illustrated in FIG. 4. This view illustrates the arrangement of moderator layer 205 and electrode layer 203.

In the embodiment, the second conductive material of moderator layer 205 comprises a silver-based material, such as a silver-based ink. This material may be substantially similar to the conductive material of moderator layer 204. The pressure sensitive material of electrode layer 203 comprises a quantum tunnelling material, for example, a quantum tunnelling composite material available from the applicant, Peratech Holdco Ltd, under the trade mark QTC®.

In the embodiment, moderator layer 205 is provided in the form of a printed pattern, and, as shown, the printed pattern comprises a plurality of dots 401 which correspond to the plurality of dots 301 of moderator layer 204 previously described in respect to FIG. 3. The dot pattern avoids shorting of the force sensing device when moderator layer 204 and moderator layer 205 are brought into contact, and thereby forces forcing the current to flow along paths within the higher resistance material of electrode layer 203.

In the embodiment, the silver-based ink dot pattern is printed onto the quantum tunnelling material which aligns with the dot arrangement shown in FIG. 3. In the embodiment, this provides silver-to-silver contacts, which removes the contact resistance by ensuring that a parallel path is created between the dots, thereby allowing current to flow through the high resistivity material.

This, in effect, gives the effect of having an increased number of parallel resistors in an electric circuit. The resistance decreases with an increased number of parallel resistors, and thus, the force sensing device enables the resistance to decrease.

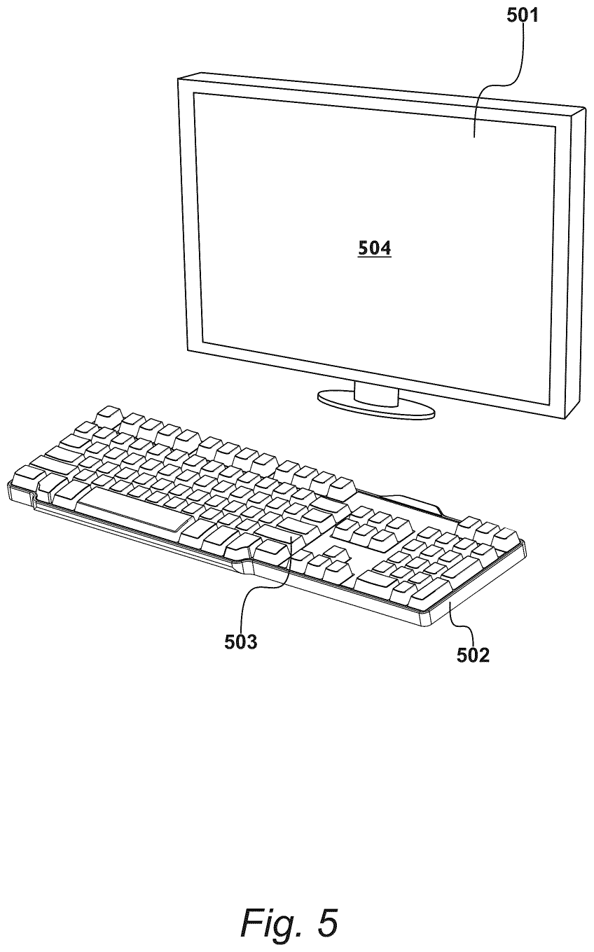

### FIG. 5

FIG. 5 shows a typical electronic device 501 comprising a keyboard 502 in accordance with an embodiment of the present invention.

In the embodiment, electronic device 501 may be a desktop computer, a notebook computer, or any other suitable type of electronic device in which a keyboard may be utilized. Keyboard 502 comprises a plurality of keys 503 which may be utilized by a user to provide an input to electronic device 501 and subsequently provide an output onto display 504 of electronic device 501.

In the embodiment, each of the plurality of keys 503 comprises a force sensing device in accordance with the present invention as described herein. The force sensing device may be utilized as part of the keyboard membrane with a force-sensitive response being providing on application of a force to any one of the plurality of keys 503. Consequently, the force sensing device described herein may provide a more appropriate and stable response even in the event of changing environmental conditions.

The invention claimed is:

1. A force sensing device, comprising:
a first electrode layer comprising a material having a first resistivity;
a second electrode layer comprising a pressure sensitive material having a second resistivity, said second resistivity being relatively high compared to said first resistivity, and, said first electrode layer and said second electrode layer arranged apart and configured to be brought together under an applied force; and
a first conductive material applied to said first electrode layer to produce a first moderator layer and a second conductive material applied to said second electrode layer to produce a second moderator layer; wherein
said first conductive material and said second conductive material each comprise a material having a substantially low resistivity, said substantially low resistivity being lower than said first resistivity and said second resistivity, such that, when said first conductive material and said second conductive material are brought into contact under said applied force, current flow between said first conductive material and said second conductive material is dependent on contact area between said first moderator layer and said second moderator layer.

2. The force sensing device of claim 1, further comprising an air gap between said first moderator layer and said second moderator layer.

3. The force sensing device of claim 1, wherein said first conductive material comprises a silver-based material.

4. The force sensing device of claim 1, wherein said second conductive material comprises a silver-based material.

5. The force sensing device of claim 1, wherein said current flow comprises a plurality of parallel paths configured to decrease an overall resistance between said first electrode layer and said second electrode layer.

6. The force sensing device of claim 1, wherein said material having a first resistivity comprises a carbon-based material.

7. The force sensing device of claim 1, wherein said pressure sensitive material comprises a quantum tunnelling material.

8. The force sensing device of claim 1, wherein said first electrode layer and said second electrode layer are provided on a first substrate and a second substrate respectively.

9. The force sensing device of claim 1, wherein said first conductive material is provided in the form of a printed pattern.

10. The force sensing device of claim 9, wherein said printed pattern comprises a plurality of interdigitated fingers.

11. The force sensing device of claim 9, wherein said printed pattern comprises a plurality of dots.

12. The force sensing device of claim 1, wherein said first electrode layer comprises a plurality of interdigitated fingers.

13. An electronic device comprising the force sensing device of claim 1.

14. The electronic device of claim 13, said electronic device comprising an electronic keyboard.
